(19) United States
(12) Patent Application Publication
(10) Pub. No.: US 2010/0203212 A1
(43) Pub. Date: Aug. 12, 2010

(54) Snack Food Chip Containing Cooked Grain And Method Of Making Same

(75) Inventor: Kraig D. Rawls, Madera, CA (US)

Correspondence Address: Myers Andras Sherman LLP, 19900 MacArthur Blvd., Suite 1150, Irvine, CA, 92612, US

(73) Assignee: Warnock Food Products, Inc., Madera, CA (US)

(21) Appl. No.: 12/705,461

(22) Filed: Feb. 12, 2010

Related U.S. Application Data
(60) Provisional application No. 61/152,211, filed on Feb. 12, 2009.

(51) Int. Cl. A23L 1/182; A23L 1/27; A21D 2/38; A21D 2/00; A23L 1/01; A21D 13/00

(52) U.S. Cl. 426/540; 426/560; 426/555

(57) ABSTRACT

Disclosed is a sheeted, baked, and fried snack chip formed by cooking grain in a heated cooking solution to form cooked grain; mixing the cooked grain with masa flour while the cooked grain is still moist to form a hybrid mix; hydrating the hybrid mix to form a dough; sheeting the dough to form a dough sheet; cutting chip-shaped dough pieces from the dough sheet, and then baking and frying the chip-shaped dough pieces to form the final snack chips. The grain may be pre-soaked prior to cooking. The grain may also be colored with a colorant to impart a color to the cooked grain that makes it visually distinct from a primary color of the dough. If a colorant is used, it may be accomplished in association with the pre-soaking step or in association with the cooking step. The grain may be rice.

### RELATED APPLICATION INFORMATION

This application claims priority under 35 USC §119(e) to U.S. provisional patent application Ser. No. 61/152,211, filed Feb. 12, 2009, entitled “Snack Food Chip Containing Cooked Grain and Method of Making Same,” the entire disclosure of which is hereby incorporated by reference.

### BACKGROUND OF THE INVENTION

1. Field of the Invention

The present invention pertains generally to method of producing prepared food products and, more particularly, to an improved snack food chip containing a cooked and distinctly colored grain and a method of making such a snack food chip.

2. Description of the Prior Art

There are many different kinds of snack food chips including tortilla chips, rice chips, etc. For purposes of this application, a snack chip may contain one or more grains (e.g. rice, wheat, oats, corn, beans, etc.) along with other ingredients. When we say that a snack chip is “based” on a particular grain (e.g. “rice-based,” “corn-based,” etc.), we mean that the noted grain is the predominant grain, by weight, such that FDA regulations would cause it to be listed before other grains within the list of ingredients.

A typical food production line for mass producing a snack food chip includes two moisture reduction stages; an oven for reducing the moisture content to a first level by baking the snack food chips and a fryer for reducing the moisture content to a second lower level by frying the snack food chips.

In one particularly efficient method of manufacturing a snack food chip, the oven and fryer are preceded by a continuously operating machine called a sheeting machine, sheeter head, or just sheeter. The sheeter compresses dough between two counter-rotating rollers to form a sheet and then uses a cutter roller to cut chip-shaped dough pieces from that sheet. (see e.g. U.S. Pat. No. 5,180,593 entitled “Sheeting Machine”, hereby incorporated by reference).

The dough must have characteristics that make it amendable to sheeting. In particular, a dough that is too sticky will not work well with a sheeter.

“Corn chips” or “tortilla chips” are examples of corn-based snack chips that are formed from a dough that uses corn as the base material. Traditionally, the corn-based dough is called “masa.” In a production environment, masa is made by steeping fresh corn in water (usually with “lime” or calcium hydroxide which makes it taste better and easier to digest) and then grinding the cooked corn into dough or, alternatively, by mixing dry cornflour (aka cornmeal) with water. In either case, because it has sufficient binding capabilities without being too sticky, masa works well in a mass production environment because it can rolled into a sheet with mechanical sheeters without sticking to the rollers.

Rice chips, on the other hand, have not been routinely manufactured in sheeter-based mass production systems because rice-based dough tends to be too sticky to work well with a mechanical sheeter.

While corn chips are certainly popular and very amenable to mass production via sheeting, there is a growing demand for rice-based chips and also for other snack food chips based on other non-corn grains that are not so amenable to sheeting. In particular, it has often been difficult to make snack food chips from dough that is based on non-corn grains (e.g. rice-based dough) because the dough tends to be so sticky that it adheres to and will not separate from the sheeter rollers.

The applicant is aware of one patent that offers one possible solution to this problem for a rice-based snack chip, namely U.S. Pat. No. 7,189,424 issued to Richard Gorski, entitled “Rice-Based Snack Chip and Method of Making Same” (hereby incorporated by reference). Gorski discloses a rice-based chip that is said to be amenable to sheeting. However, all of his embodiments and all of his claims require a rice-based dough that includes at least one kind of rice flour and a relatively unusual and quite expensive ingredient based on a product called “bumped rice.” Bumped rice is normally used by cereal makers to make a “highly expanded” cereal product called rice crisp (Kellog's® “Rice Krispies”® being one well-known example).

Gorski discloses the use of “at least two different rice materials,” col. 1, lines 40-41, and using “pregelatinized long-grain rice flour,” “medium-grain coarse rice flour,” and what amounts to a special ingredient, his so-called “rebumped bumped rice.”

As to the “bumped rice” used to make his rebumped bumped rice, Gorski describes it in great detail at col. 1, line 61 to col. 2, line 7. Gorski says that bumped rice consists of thin, hard, disk-shaped kernels that are manufactured from rice kernels that are:

(1) cooked for several hours,

(2) dried to 25-30% moisture content,

(3) tempered for 15 minutes,

(4) dried again to an 18-20% moisture content,

(5) radiantly heated to “plasticize” the outer layers,

(6) “bumped” between widely spaced flaking rolls, and finally

(7) tempered for 24 hours.

Gorski's apparent invention was using the bumped rice as an ingredient in his rice-based dough so that it is amenable to sheeting. The bumped rice starts out hard and dry. As noted above, one of the several steps needed to create bumped rice is squeezing the rice between widely spaced rollers. With this in mind, it appears that Gorski calls the bumped rice within his rice-based chips “rebumped bumped rice” because the dry previously-bumped rice is partially hydrated in his rice based dough and, when sheeted, is squeezed again between the rollers of the sheeting machine. (col. 2, lines 36-39). He notes, however, that the rebumped bumped rice does not puff up when the dough is cut into chips, partially dehydrated in an oven, and fried in a fryer. He says that they enlarge only slightly and they are crisp and crunchy but not airy. (col. 2, lines 41-48).

Gorski discloses a rice-based chip product that can be made by conventional sheeting methods, but his mix and related method detrimentally require the use of a dry, hard and relatively expensive ingredient that can be only be purchased from a few suppliers in the United States; namely bumped rice. There remains a need, therefore, for a rice-based snack food chip that can be sheeted in a more cost effective manner without requiring bumped rice.

Visual appearance is also a factor. There are existing rice-based snack chips in the market place including “Lundberg”-brand rice chips that are distributed in packing that references the Gorski patent. While the “Lundberg”-brand rice chips have a good appearance in that the “rebumped bumped rice” is visually distinct from the remainder of the chip, bumped rice is an expensive ingredient. There remains a need, therefore, for a rice-based snack food chip that contains visually distinct grains that can be made in a more cost effective manner, i.e. without using bumped rice.

### BRIEF SUMMARY OF THE INVENTION

The present invention specifically addresses and alleviates the above mentioned deficiencies associated with the prior art. More particularly, the present invention, in a preferred embodiment is, a sheeted, baked, and fried snack chip formed by cooking grain in a heated cooking solution to form cooked grain; mixing the cooked grain with masa flour while the cooked grain is still moist to form a hybrid mix; hydrating the hybrid mix to form a dough; sheeting the dough to form a dough sheet; cutting chip-shaped dough pieces from the dough sheet, and then baking and frying the chip-shaped dough pieces. The grain may be pre-soaked prior to cooking. The grain may also be colored with a colorant to impart a color to the cooked grain that makes it visually distinct from a primary color of the dough. If a colorant is used, it may be accomplished in association with the pre-soaking step or in association with the cooking step. Other embodiments are more fully described below.

While the apparatus and method has or will be described for the sake of grammatical fluidity with functional explanations, it is to be expressly understood that the claims, unless expressly formulated under 35 USC §112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC §112 are to be accorded full statutory equivalents under 35 USC §112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a flowchart showing a method of making a snack food chip according to a first embodiment of the invention;

FIG. 2 shows one possible system for implementing the first embodiment by cooking and coloring, flouring, and partially drying rice kernels that have a skin covering a moist and chewy interior, the cooked rice then being combined with dry ingredients to form a “hybrid mix” (as opposed to a conventional dry mix containing all dry ingredients);

FIG. 3 is a flowchart showing a presently method of making a snack food chip according to a preferred embodiment of the invention;

FIG. 4 shows a system for implementing the preferred embodiment by pre-soaking (and optionally coloring) and then cooking rice kernels, the cooked rice then being combined with dry ingredients to form a “hybrid mix” as above; and

FIG. 5 is an illustration of a snack food chip made according to an embodiment of the invention involving rice kernels that were cooked, floured and partially dried, but not colored, the rice kernels being visible but not prominently; and

FIG. 6 is an illustration of a snack food chip made according to an embodiment of the invention involving rice kernels that were cooked and colored, the rice kernels being visually prominent as suggested by the illustration.

### DETAILED DESCRIPTION OF THE PREFERRED EMBODIMENTS

### First Embodiment

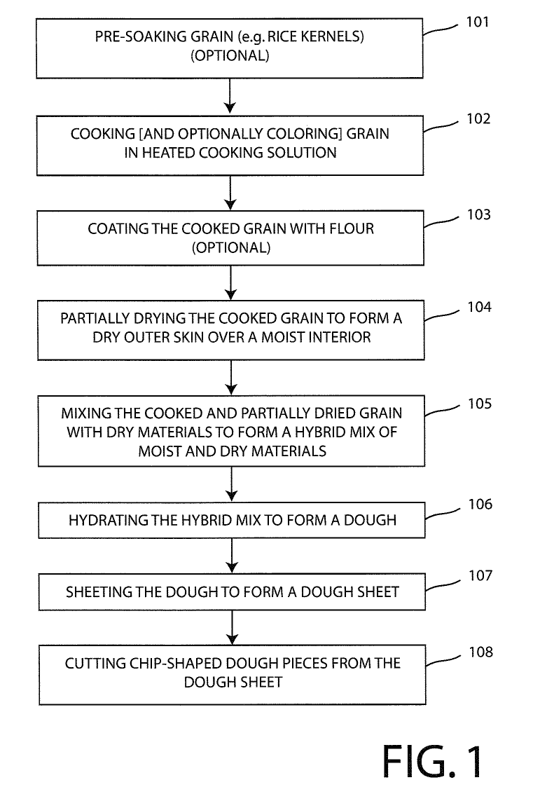

FIG. 1 is a flow chart depicting an exemplary method of producing a snack food chip according to a first embodiment of the invention.

In Step 101, the method involves pre-soaking a grain or seed kernel (e.g. rice kernels). This pre-soaking step is regarded as optional, but is presently preferred for rice kernels because it provides certain benefits including a faster cooking time during the subsequent cooking step and, under certain circumstances, eliminates the need to coat the cooked grain with flour to avoid clumping during the drying steps. If used, the pre-soaking step may be accomplished in batches or in a continuous environment provided that the grain is pre-soaked for the desired soak time (e.g. about 30 minutes for rice kernels). If batch processed in “soak tanks”, the water would be drained at the appropriate time and the pre-soaked grain would be metered into the cooking system (discussed below). While rice kernels may be pre-soaked to a desired hydration state in about 30 minutes, other grains may vary. It is believed, for example, that barley and wheat kernels would benefit from a longer pre-soak time of about three (3) hours. Other grains may benefit from more or less time.

In Step 102, the method involves cooking and optionally coloring the grain in a heated cooking solution (liquid, gas, or both). Typically this would involve a heated solution consisting primarily of water (liquid, steam, or both) and, if natural or artificial coloring is desired and not introduced in an earlier step, a colorant such as caramel (e.g. caramel color #528 manufactured by D.D. Williamson) or other suitable food coloring. In this first embodiment, the grain used is brown rice, the cooking solution includes a liquid component and is heated by steam to a temperature of about 170° F., and the rice kernels are cooked in the heated cooking solution for about ten (10) minutes if not pre-soaked. If pre-soaked for about thirty (30) minutes, the cooking time can be reduced to about four (4) minutes. For other grains, e.g. barley, the preferred temperature would be about 200° F.

If the optional coloring is added to the cooking solution, the resulting snack food chip may beneficially have whole grain kernels that are much more visually distinct from the remainder of the chip than in the absence of such coloring. If the colorant is brown, then the colored grain will beneficially take on a toasted appearance. However, colors other than brown may be used for different effects (e.g. red and green colors for chips sold during the Christmas season, etc.).

In Step 103, the method involves coating the cooked grain with flour. This step is also optional, but highly preferred in some circumstances because it helps prevent the cooked grain, which is usually moist and sticky, from clumping together and/or sticking to the machinery before being partially dried. It has been found that with certain grains (e.g. rice kernels) and certain cooking equipment (e.g. a continuous auger-based cooking system 30 as discussed below), pre-soaking the grain may speed up the cooking time which reduces the amount of grain contained within the helical gaps of the auger-based cooking system that, in turn, eliminates the need to coat the rice kernels with flour. It may also be possible to omit the flouring altogether if the particular grain does not tend to clump up after cooking or, where clumping is not an issue but sticking is, if the equipment surfaces downstream of the cooking step are themselves treated with non-stick coating. Also, any other coating known to prevent sticking or clumping may be used (e.g. commercial cooking sprays). The preferred coating flour is one made from the same grain used in the cooking and drying steps, but other flours may have utility.

In Step 104, the method involves partially drying the cooked grain to form a dry outer skin over an otherwise moist interior. In this embodiment, the cooked grain consists of brown rice kernels and the cooked rice is partially dried by spending about 2-3 minutes in a dryer that has a temperature of about 350° F. This step is believed to be important to making it possible to readily use a cooked and still moist grain in a sheeting process. In the case of cooked brown rice, the partially dried rice kernels are relatively dry to the touch, but they kernel beneath the skin still has a soft and chewy texture.

In Step 105, the method involves mixing the cooked and partially dried grain with dry materials to form a hybrid mix (as opposed to a conventional “dry mix”) that contains a mixture of both moist materials (the cooked and partially dried grain) and the dry materials. The preferred dry materials include flour made from the same grain used in the cooking and partial drying steps (the proportional amount of which may be adjusted so that the overall snack food chip may be properly designated as a chip made primarily from the grain in question) and, usually, a smaller portion of corn masa flour which tends to make the resulting dough more amenable to processing with a mechanical sheeter in a conventional manufacturing process.

In Step 106, the method involves hydrating the hybrid mix to form dough. This hydrating step is accomplished by simply adding a desired amount of water to the hybrid mix and mixing the two together in a conventional mixer. The inventors contemplate that the hybrid mix will be formed and then hydrated as a whole, but it is possible in some if not all cases to form a conventional dry mix that contains only dry materials, hydrate that dry mix into a preliminary dough, and then mix the cooked and partially dried grain into that preliminary dough to form the final dough. In other words, the precise order may not be critical.

In Steps 107 and 108, the method involves sheeting the dough into a dough sheet and cutting chip-shaped dough pieces from the dough sheet. Subsequently, as is well known to those who operate the associated equipment, the snack food chips will be dehydrated to form a crisp snack food chip. Typically, this is accomplished with an oven and then with a fryer.

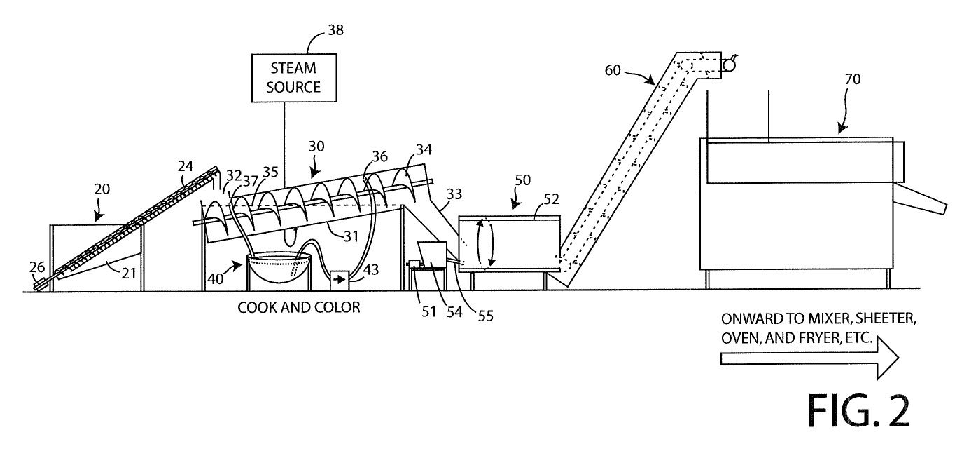

FIG. 2 shows an exemplary machinery line for cooking and coloring, flouring, and partially drying rice kernels that are then added to a dry mix to form a hybrid mix according to a first embodiment of the invention. As shown, and while temporarily skipping over some other components that we will cover in more detail below, the line generally comprises: (1) a hopper system 20 containing uncooked rice; (2) a cooking system 30 for cooking the rice in a heated cooking solution; (3) a flouring tumbler 50 for coating the cooked rice with flour (preferably rice flour); and (4) a dryer 70 for partially drying the cooked and floured rice.

Focusing on FIG. 2, one can see that the hopper system 20 generally comprises a hopper 21, an auger tube 24, and a motor 26 for turning an auger (not shown) that extends from the hopper 21 to a distal end of the auger tube 24. When the motor 26 turns the auger, uncooked rice kernels are continuously advanced at a desired rate. The uncooked rice kernels move from the hopper 21, out to the distal end of the auger tube 24, and are then discharged into the next portion of the line—namely the cooking system 30. As shown, the auger tube 24 discharges into the input 32 of the cooking tank 31.

As shown in FIG. 2, the cooking system 30 continuously cooks the rice kernels in a heated cooking solution using an auger 34. As shown, the cooking system 30 includes a tank 31 that is angled upward such that its output chute 33 is higher than its input 32. As a natural result of gravity, the heated cooking solution seeks a solution level 35 within the tank 31 such that the solution level is deeper at the input end 32 of the tank than at the output chute 33 where there is no solution at all. As the auger 34 turns, the rice kernels are advanced through the cooking solutions at a desired rate toward the output chute 33, where they are discharged into the next portion of the line—namely the flouring tumbler 50.

In the cooking system 30, the auger 34 is about twelve (12) feet long and it is rotated at an appropriate number of RPMs such that it takes about eleven (11) minutes for the rice kernels to pass through the cooking system 30. If the kernels are pre-soaked, however, it has been found that the auger 34 may be rotated at higher number of RPMs to pass the kernels through the cooking system in a shorter period of time, e.g. about four (4) minutes. At the relatively slower rate of revolution, it has been found that the channels in the auger 34 are much fuller such that the cooked rice tends to bunch and stick together in the absence of the optional coating step discussed below. At the faster rate of revolution, there is less rice in the auger's helical gap and it may be possible to omit the flouring step and not experience any clumping in subsequent processing steps.

For cooking the rice kernels, the cooking system 30 uses a steam jacket located next and/or within the tank 31. The steam jacket receives steam from a nearby steam source 38. The exact details of the steam source 38 and steam jacket (symbolized by the arrow from the source) are omitted from this description for the sake of brevity as such items are well known to those of ordinary skill in the art. In addition, any other form of heat may be used including, for example, electric heating elements, gas flame, etc.

Because some portion of the cooking solution will be lost through absorption into the rice kernels and by evaporation, a makeup solution tank 40 is provided to continuously account for such losses. In other words, by continually pumping the cooking solution into and out of the makeup solution tank 40, the cooking solution within the cooking system 30 is kept at the desired solution level 35. Basically, an additional amount of cooking solution is held with the makeup solution tank 40, and that additional solution is continuously circulated into the cooking tank 31 with a pump 43. The pump 43 draws solution from the tank 40, injects it into the tank 31 at a cooking solution input 36. At the same time, overflow solution exits the tank 31 at a cooking solution output 37 and flows back into the tank 40.

FIG. 2 also shows a flouring tumbler 50. Such tumblers are well known to those in the art. As shown, a motor 51 rotates a barrel 52 as suggested by the circular arrows) and operates a flour supply 54 having a flour introducer 55 extending into the input end of the barrel 52. The barrel 52 is held at a slight angle with its input end slightly higher than its output end. In operation, the barrel 52 rotates around and the cooked rice kernels are introduced into the barrel 52 along with flour from the flour introducer 55. As a result, the cooked rice kernels are quickly and thoroughly coated with flour and are simultaneously prevented from clumping together.

FIG. 2 further shows an inclined conveyor 60 and a dryer 70 at the output end of the flouring tumbler 50. The inclined conveyor 60 is provided in this particular embodiment because this particular dryer 70 has a relatively high construction with an input on its top. Although they remain quite soft inside, the dryer 70 partially dries the cooked and floured rice kernels so that they form a little bit of a skin while remaining somewhat moist and chewy beneath the skin. This partial drying operation allows the cooked rice to be sheeted without being fully dry. The inventor believes that the skin of the partially dried rice allows the soft, cooked rice kernel to be sheeted because it is compressed but not smeared into a sticky mess.

The presently preferred dryer 70 is similar to those used to make popcorn. It has a rotary drum that tumbles the grain as it passes through the dryer and is subjected to heat. However, any suitable dryer may be used including, but not limited to, a belt dryer.

After the cooked grains (e.g. rice kernels) are partially dried by the dryer 70, they can be combined with other ingredients in a so-called “hybrid mix.” Usually, a number of dry ingredients are combined to form a “dry mix” and then that dry mix is transformed into a dough by hydrating it with a suitable amount of water in a mixer. Here, however, various desired dry ingredients are combined with the cooked and partially dried grains (which are moist and chewy inside and not really dry)—hence the term “hybrid mix.”

In this embodiment, a small portion of the hybrid mix was formed by combining the following ingredients in the noted amounts (and corresponding proportions) in a mixer for about one (1) minute:

| | | |
|---|---|---|
| 22.8 | lbs | Sage 5 Rice Flour (pre-gelatinized long grain white rice flour) |
| 22.7 | lbs | Tortilla Chip I (masa flour) |
| 2.8 | lbs | Sesame Seeds (for flavor) |
| 15 | lbs | cooked rice (optional dried, optionally colored) |

After the pre-mix operation, the hybrid mix was combined with the following amount of water and mixed for two (2) minutes:

| | |
|---|---|
| 59 lbs | Water |

### Second Embodiment

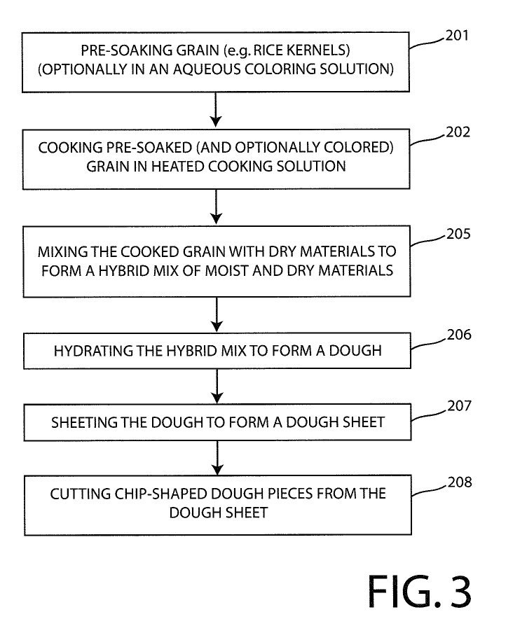

FIG. 3 is a flow chart depicting a second, presently preferred method of producing a snack food chip according a second, more efficient embodiment of the invention. For purposes of clarity and comparison, in FIGS. 1 and 3, similar steps have similar numbers (e.g. steps 101 and 201).

This second embodiment is similar to the first embodiment, but certain steps have been omitted and certain related equipment has been eliminated. In particular, it has been confirmed that if the cooked grains are pre-soaked, then the flouring step may be omitted and, moreover, if added color is desired (as with rice), the pre-soaking solution may include the colorant to more thoroughly impart the color and with less subsequent smearing such that colorant need not be added to the cooking solution (nor replenished) and such that the partial drying step (and related dryer) may be omitted.

In Step 201, the method involves pre-soaking a grain or seed kernel (e.g. rice kernels). This pre-soaking step, previously regarded as optional, is now preferred and, where a colored grain is desired (as with rice), is now the preferred point in the process for coloring the grain.

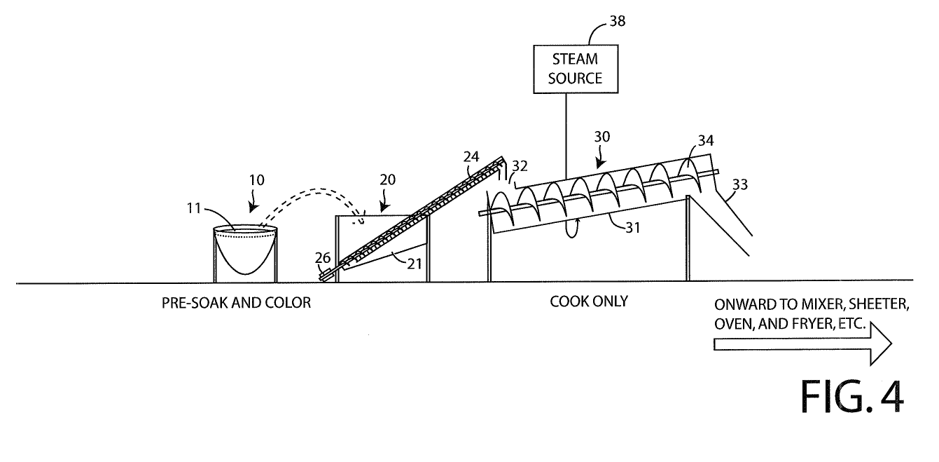

FIG. 4 illustrates a pre-soaking system 10 that contains a pre-soaking liquid 11 which may be clear water or may be a solution of water and a desired colorant. While the proportions may change based on the colorant and/or grain being used, the Applicant has determined that the following ratio of colorant to water performs well with rice:

1½ cups of caramel food coloring

2½ gallons of water

When used with rice, the first method described above contemplated a pre-soaking time of about 30 minutes. However, it has been determined that pre-soaking the rice for a bit longer, for about an hour, is preferred for a more thorough impartation of color to the rice during this operation. To date, the pre-soaking has been accomplished with cold water, but the inventor believes that using hot water or heating the aqueous colorant solution during the pre-soaking may reduce the time required to soften the grains, deepen the color, or both.

In FIG. 4, as suggested by the dashed arrows, the pre-soaked and pre-colored rice is transported in batches to the hopper system 20 which, as before, uses an auger 24 turned by a motor 26 to meter the rice kernels out of the hopper 21 and into the input 32 of the cooking system 30. Here, however, the cooking system 30 only uses a steam source 38 and associated steam jacket (suggested by the arrow leading from steam source 38), and beneficially does not require a liquid solution, as before, because it is used only to cook the rice kernels, not to color them. Accordingly, it is no longer necessary to use a makeup solution tank 40 as was required in the first embodiment of FIGS. 1 and 2. This newly preferred approach has the added benefit of eliminating the variance in the color imparted to the rice kernels by eliminating the need to replenish the water and colorant in the makeup solution tank 40.

The applicant has also determined that the flouring tumbler 50 and dryer 70 may be omitted without undue detriment, the dry mixing step being sufficient to un-clump the cooked (and possibly colored) rice kernels.

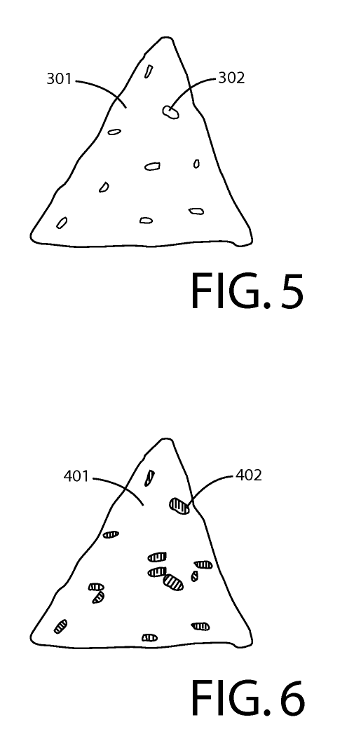

Regardless of the method used, if colorant is employed, the present invention beneficially creates a visually desirable snack food chip. FIG. 5 is an illustration of a snack food chip made according to an embodiment of the invention involving rice kernels that were cooked, but not colored, the rice kernels being visible but not prominently so. FIG. 6, on the other hand, is an illustration of a snack food chip made according to an embodiment of the invention involving rice kernels that were cooked and colored, the rice kernels being visually prominent as suggested by the illustration.

While the above embodiments relate specifically to a rice-based snack food chip formed by creating a sheeting-friendly dough from a hybrid mix containing masa flour, rice flour, and cooked rice, it is possible of course to form a similar hybrid mix containing alternative cooked grains to form grain-based chips other than rice chips. The alternative grains include, but are not limited to, wheat, beans, amaranth, buckwheat, barley, faro, bulgur wheat, flaxseed, kamut, millet, guinea, rye, spelt, and triticale.

While the particular process that is shown and disclosed in detail is fully capable of obtaining the objects and providing the advantages herein before stated, it is to be understood that it merely illustrates the presently preferred embodiment of the invention and that no limitations are intended to be confined to the details of the preferred equipment or illustrated process shown and described herein, other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A sheeted, baked, and fried snack chip formed by:
cooking grain other than corn in a heated cooking solution to form cooked grain;
mixing the cooked grain with masa flour while the cooked grain is still moist to form a hybrid mix;
hydrating the hybrid mix to form a dough;
sheeting the dough to form a dough sheet;
cutting chip-shaped dough pieces from the dough sheet; and
baking and then frying the chip-shaped dough pieces.

2. The sheeted, baked, and fried snack food chip of claim 1 wherein the heated cooking solution comprises steam.

3. The sheeted, baked, and fried snack food chip of claim 1 further comprising the step of pre-soaking the grain in water prior to cooking the grain.

4. The sheeted, baked, and fried snack food chip of claim 1 further comprising the step of coloring the grain with a colorant to impart a color to the grain, the color of the grain being visually distinct from a primary color of the dough.

5. The sheeted, baked, and fried snack food chip of claim 4 further comprising the step of pre-soaking the grain in water prior to cooking the grain.

6. The sheeted, baked, and fried snack chip of claim 5 wherein the pre-soaking and coloring are accomplished together by adding the colorant to the water.

7. The sheeted, baked, and fried snack chip of claim 4 wherein the cooking and coloring are accomplished together by adding the coloring to the heated cooking solution.

8. The sheeted, baked, and fried snack chip of claim 4 wherein the color is brown to provided the cooked grain with a toasted appearance relative to the primary color of the dough.

9. The sheeted, baked, and fried snack chip of claim 8 wherein the colorant comprises caramel.

10. The sheeted, baked, and fried snack chip of claim 8 wherein the colorant comprises malt.

11. The sheeted, baked, and fried snack chip of claim 1 further formed by:
Adding at least one other grain product that is based on the same grain to the hybrid mix, the cooked grain and the at least one other grain product collectively forming a major component of the hybrid mix by weight.

12. The sheeted, baked, and fried snack chip of claim 11 wherein the other grain product is a flour formed from the grain.

13. The sheeted, baked, and fried chip of claim 1 further comprising:
partially drying the cooked grain before mixing.

14. The sheeted, baked, and fried snack chip of claim 13 wherein the partial drying is accomplished by tumbling the cooked grain through a heated drum.

15. The sheeted, baked, and fried snack chip of claim 14 further including coating the cooked grain with flour to reduce clumping while tumbling the cooked grain through the heated drum.

16. The sheeted, baked, and fried snack chip of claim 15 wherein the grain is rice.

17. The sheeted, baked, and fried snack chip of claim 16 wherein the flour is rice flour.

18. The sheeted, baked, and fried snack chip of claim 1 wherein the grain comprises at least one of rice, wheat, beans, amaranth, buckwheat, barley, faro, bulgur wheat, flaxseed, kamut, millet, guinea, rye, spelt, and triticale.

19. A sheeted, baked, and fried rice-based snack chip formed by:
cooking rice in a heated cooking solution to form cooked rice;
mixing the cooked rice with masa flour and rice flour while the rice is still moist to form a hybrid mix, the cooked rice and the rice flour collectively constituting a major component of the hybrid mix by weight;
hydrating the hybrid mix to form a dough;
sheeting the dough to form a dough sheet;
cutting chip-shaped dough pieces from the dough sheet; and
baking and then frying the chip-shaped dough pieces.

20. The sheeted, baked, and fried rice-based snack chip of claim 19 wherein the heated cooking solution comprises steam.

21. The sheeted, baked, and fried rice-based snack chip of claim 19 comprising the further step of pre-soaking the rice in water prior to cooking the rice.

22. The sheeted, baked, and fried rice-based snack chip of claim 19 further comprising the step of coloring the rice with a colorant to impart a color to the rice, the color of the rice being visually distinct from the remainder of the dough.

23. The sheeted, baked, and fried rice-based snack chip of claim 22 further comprising the step of pre-soaking the rice in water prior to cooking the rice.

24. The sheeted, baked, and fried rice-based snack chip of claim 23 wherein the pre-soaking and coloring are accomplished together by adding the colorant to the water.

25. The sheeted, baked, and fried rice-based snack chip of claim 22 wherein the cooking and coloring are accomplished together by adding the coloring to the heated cooking solution.

26. The sheeted, baked, and fried snack chip of claim 22 wherein the color is brown to provided the cooked rice with a toasted appearance relative to the primary color of the dough.

27. The sheeted, baked, and fried rice-based snack chip of claim 26 wherein the colorant comprises caramel.

28. The sheeted, baked, and fried rice-based snack chip of claim 26 wherein the colorant comprises malt.

29. The sheeted, baked, and fried rice-based snack chip of claim 19 further comprising the step of partially drying the cooked rice by tumbling the cooked rice through a heated drum.

30. The sheeted, baked, and fried rice-based snack chip of claim 29 further including coating the cooked rice with flour while tumbling the cooked rice through the heated drum to reduce clumping.

31. A hybrid mix for producing a rice-based snack food chip by combining the hybrid mix with water to form a dough that is sheeted, baked and fried, the hybrid mix comprising:
non-rice ingredients; and
rice-based ingredients that constitute a major component of the dry ingredients by weight, the rice-based ingredients including rice that has been cooked in a heated cooking solution.

32. The hybrid mix of claim 31 wherein the rice that has been cooked has also been colored to have a color that is visually distinct from the other ingredients in the rice-based snack food chip.

33. The hybrid mix of claim 31 wherein the non-rice ingredients comprise masa flour.

34. The hybrid mix of claim 31 wherein the rice-based ingredients further comprise rice flour.

35. The hybrid mix of claim 31 wherein the rice flour is white pre-gelatinized long grain rice flour.

36. The hybrid mix of claim 32 wherein the color is brown to provided the cooked and colored rice with a toasted appearance.

37. The hybrid mix of claim 36 wherein the cooked and colored rice is colored brown with a food coloring comprising caramel food coloring.

38. The hybrid mix of claim 36 wherein cooked and colored rice is colored brown with a food coloring comprising malt.

39. The hybrid mix of claim 31 wherein the cooked rice is dried prior to being combined with the other ingredients in the hybrid mix.

40. The hybrid mix of claim 39 wherein the cooked rice is further coated with rice flour prior to being dried.

41. A hybrid mix for producing a rice-based snack food chip by combining the hybrid mix with water to form a dough that is sheeted, baked and fried, the hybrid mix comprising:
non-rice ingredients; and
rice-based ingredients that constitute a major component of the dry ingredients by weight, the rice-based ingredients including rice that has been cooked in a heated cooking solution and colored to have a color that is visually distinct from the other ingredients in the rice-based snack food chip.

42. The hybrid mix of claim 41 wherein the non-rice ingredients comprise masa flour.

43. The hybrid mix of claim 41 wherein the rice-based ingredients further comprise rice flour.

44. The hybrid mix of claim 41 wherein the rice flour is white pre-gelatinized long grain rice flour.

45. The hybrid mix of claim 41 wherein the color is brown to provided the cooked and colored rice with a toasted appearance.

46. The hybrid mix of claim 44 wherein the cooked and colored rice is colored brown with a food coloring comprising caramel food coloring.

47. The hybrid mix of claim 44 wherein the cooked and colored rice is colored brown with a food coloring comprising malt.

48. The hybrid mix of claim 41 wherein the cooked and colored rice is partially dried prior to being combined with the other ingredients in the hybrid mix.

49. A hybrid mix for producing a rice-based snack food chip by combining the hybrid mix with water to form a dough that is sheeted, baked and fried, the hybrid mix comprising:
non-rice ingredients including masa flour; and
rice-based ingredients that constitute a major component of the dry ingredients by weight, the rice-based ingredients including rice flour and rice that has been cooked in a heated cooking solution, and colored to have a color that is visually distinct from the other ingredients in the rice-based snack food chip, the color being brown to provide the cooked and colored rice with a toasted appearance.

50. The hybrid mix of claim 49 wherein the rice flour is white pre-gelatinized long grain rice flour.

51. The hybrid mix of claim 49 wherein the cooked and colored rice is colored brown with a food coloring comprising caramel food coloring.

52. The hybrid mix of claim 49 wherein cooked and colored rice is colored brown with a food coloring comprising malt.

53. The hybrid mix of claim 49 wherein the cooked and colored rice is partially dried prior to being combined with the other ingredients in the hybrid mix.

54. The hybrid mix of claim 53 wherein the cooked and colored rice is further coated with rice flour prior to being partially dried to reduce clumping.

55. A snack food chip formed by hydrating a hybrid mix with water to form a dough that is sheeted, baked and fried, the hybrid mix comprising:
ingredients that collectively provide the snack food chip with a primary color; and
seed kernels that have been cooked in a heated cooking solution and colored to have a discrete color that is visually distinct from the primary color of the snack food chip.

56. The hybrid mix of claim 55 wherein the ingredients include masa flour.

57. The snack food chip of claim 55 wherein the ingredients include a related ingredient that originates from the same plant as the seed kernels.

58. The snack food chip of claim 57 wherein the related ingredient and seed kernels form a major component of the snack food chip by weight.

59. The snack food chip of claim 58 wherein the seed kernels are rice kernels and wherein the related ingredient is rice flour.

60. The snack food chip of claim 59 wherein the rice flour is white pre-gelatinized long grain rice flour.

61. The snack food chip of claim 55 wherein the discrete color is brown to provide the seed kernels with a toasted appearance relative to the primary color of the snack food chip.

62. The snack food chip of claim 61 wherein the discrete color of brown is accomplished with caramel food coloring.

63. The snack food chip of claim 61 wherein the discrete color of brown is accomplished with malt.

64. The snack food chip of claim 55 wherein the seed kernels are dried to prevent the discrete color of the seed kernels from bleeding into the primary color of the snack food chip.

65. The snack food chip of claim 64 wherein the seed kernels are coated with flour prior to being dried to minimize clumping.

66. A sheeted, baked, and fried snack chip formed by:
providing seed kernels;
coloring the seed kernels with a colorant to impart a color to the seed kernels;
cooking the seed kernels in a heated cooking solution to form cooked seed kernels;
mixing the cooked and colored seed kernels with masa flour while the cooked and colored seed kernels are still most to form a hybrid mix;
hydrating the hybrid mix to form a dough, the color of the cooked and colored seed kernels being visually distinct from a primary color of the dough;
sheeting the dough to form a dough sheet;
cutting chip-shaped dough pieces from the dough sheet; and
baking and then frying the chip-shaped dough pieces.

67. The sheeted, baked, and fried snack chip of claim 66 further comprising the step of pre-soaking the grain in water prior to cooking the grain.

68. The sheeted, baked, and fried snack chip of claim 67 wherein the pre-soaking and coloring are accomplished together by adding the colorant to the water.

69. The baked and fried snack chip of claim 66 further formed by:
Adding to the hybrid mix at least one other ingredient that originates from the same plant as the cooked and colored seed kernels, the cooked and colored seed kernels and the at least one other ingredient collectively forming a major component of the baked and fried snack chip by weight.

70. The baked and fried snack chip of claim 69 wherein the at least one other ingredient is a flour.

71. The baked and fried chip of claim 66 further comprising:
partially drying the cooked and colored seed kernels before mixing.

72. The baked and fried snack chip of claim 66 wherein the cooking and coloring are accomplished together by adding the colorant to the heated cooking solution.

73. The baked and fried snack chip of claim 66 wherein the color is brown to provide the cooked and colored seed kernels with a toasted appearance relative to a primary color of the dough.

74. The baked and fried snack chip of claim 73 wherein the colorant comprises caramel.

75. The baked and fried snack chip of claim 74 wherein the colorant comprises malt.

76. The baked and fried snack chip of claim 71 wherein the partial drying is accomplished by tumbling the cooked and colored seed kernels through a heated drum.

77. The baked and fried snack chip of claim 76 further including coating the cooked and colored seed kernels with flour to reduce clumping while tumbling the cooked and colored seed kernels through the heated drum.

78. The baked and dried snack chip of claim 77 wherein the seed kernels are rice kernels.

79. The baked and fried snack chip of claim 78 wherein the flour is rice flour.

80. The baked and fried snack chip of claim 66 wherein the seed kernels comprise at least one of rice, wheat, beans, amaranth, buckwheat, barley, faro, bulgur wheat, flaxseed, kamut, millet, guinea, rye, spelt, and triticale.
